(19) United States
(12) Patent Application Publication
(10) Pub. No.: US 2018/0022346 A1
(43) Pub. Date: Jan. 25, 2018

(54) Vehicle Control Apparatus, Distance Calculation Apparatus, and Distance Calculation Method

(71) Applicant: Hitachi Automotive Systems, Ltd., Hitachinaka-shi, Ibaraki (JP)

(72) Inventor: Takuya MURAKAMI, Fujisawa-shi, Kanagawa (JP)

(21) Appl. No.: 15/547,538

(22) PCT Filed: Jan. 21, 2016
(86) PCT No.: PCT/JP2016/051632

§ 371 Date: Jul. 31, 2017

(30) Foreign Application Priority Data
Feb. 2, 2015 (JP) 2015-018284

(51) Int. Cl. B60W 30/085; B62D 15/02; B60W 10/20; G01C 3/06; B60W 10/04; B60T 7/12; B60W 10/22; B60G 17/015; B60W 10/18

(52) U.S. Cl. CPC B60W 30/085; B60G 17/015; B62D 15/0265; B60W 10/20; B60W 10/18; B60W 10/04; B60T 7/12; B60W 10/22; G01C 3/06; B62D 5/04

(57) ABSTRACT

Provided are a vehicle control apparatus, a distance calculation apparatus, and a distance calculation method capable of calculating a distance between a vehicle and an object even when the vehicle is stopped. A posture of the vehicle is changed while the vehicle is stopped and the distance to the object is calculated based on information imaged by a camera and the change in the posture by a vehicle posture control unit.

### TECHNICAL FIELD

The present invention relates to a vehicle control apparatus, a distance calculation apparatus, and a distance calculation method.

### BACKGROUND ART

As this kind of technique, there is disclosed a technique discussed in the following patent literature, PTL 1. PTL 1 discloses an apparatus that calculates a distance from a vehicle where this apparatus is mounted to an object targeted for a distance calculation based on images that an imaging unit captures from this vehicle while the vehicle is running.

### CITATION LIST

### Patent Literature

PTL 1: Japanese Patent Application Public Disclosure No. 2009-210424

### SUMMARY OF INVENTION

### Technical Problem

The above-described conventional technique has such a drawback that the distance cannot be calculated when this vehicle is stopped.

The present invention has been made focusing on the above-described drawback, and an object thereof is to provide a vehicle control apparatus, a distance calculation apparatus, and a distance calculation method capable of calculating the distance between the vehicle and the object even when the vehicle is stopped.

### Solution to Problem

To achieve the above-described object, one aspect of the present invention is configured to change a posture of a vehicle while the vehicle is stopped and calculate a distance to an object based on information imaged by a camera and the change in the posture by a vehicle posture control unit.

A second aspect of the present invention is configured to calculate a distance to an object based on information imaged by a monocular camera before and after a position of the camera is changed while a vehicle is stopped.

A third aspect of the present invention is configured to image an object in a predetermined direction of a vehicle with use of a camera and calculate a distance to the object based on information of the imaging before an actuator mounted on the vehicle and configured to control a posture of the vehicle is driven and of the imaging after the actuator is driven.

According to the aspects of the present invention, the distance between the vehicle and the object can be calculated even when the vehicle is stopped.

### BRIEF DESCRIPTION OF DRAWINGS

FIG. 1 illustrates a configuration of a vehicle to which a parking assist apparatus according to a first embodiment is applied.

FIG. 2 illustrates a configuration of the parking assist apparatus according to the first embodiment

FIG. 3 illustrates a configuration of parking assist control performed by an electronic control unit according to the first embodiment.

FIG. 4 is a flowchart illustrating a flow of distance measurement control while a vehicle is running according to the first embodiment.

FIG. 5 is a flowchart illustrating a flow of distance measurement control while the vehicle is stopped according to the first embodiment.

FIG. 6 schematically illustrates a front left or right wheel according to the first embodiment.

FIG. 7 illustrates the configuration of the vehicle to which the parking assist apparatus according to the first embodiment is applied.

FIG. 8 is a flowchart illustrating a flow of distance measurement control while the vehicle is stopped according to a second embodiment.

FIG. 9 schematically illustrates a vehicle according to a second embodiment.

FIG. 10 illustrates a method for calculating a distance between the vehicle and an obstacle according to the second embodiment.

FIG. 11 is a flowchart illustrating a flow of distance measurement control while the vehicle is stopped according to a third embodiment.

FIG. 12 illustrates a method for calculating the distance between the vehicle and the obstacle according to the third embodiment.

### DESCRIPTION OF EMBODIMENTS

### First Embodiment

First, a configuration will be described.

### [Configuration of Vehicle]

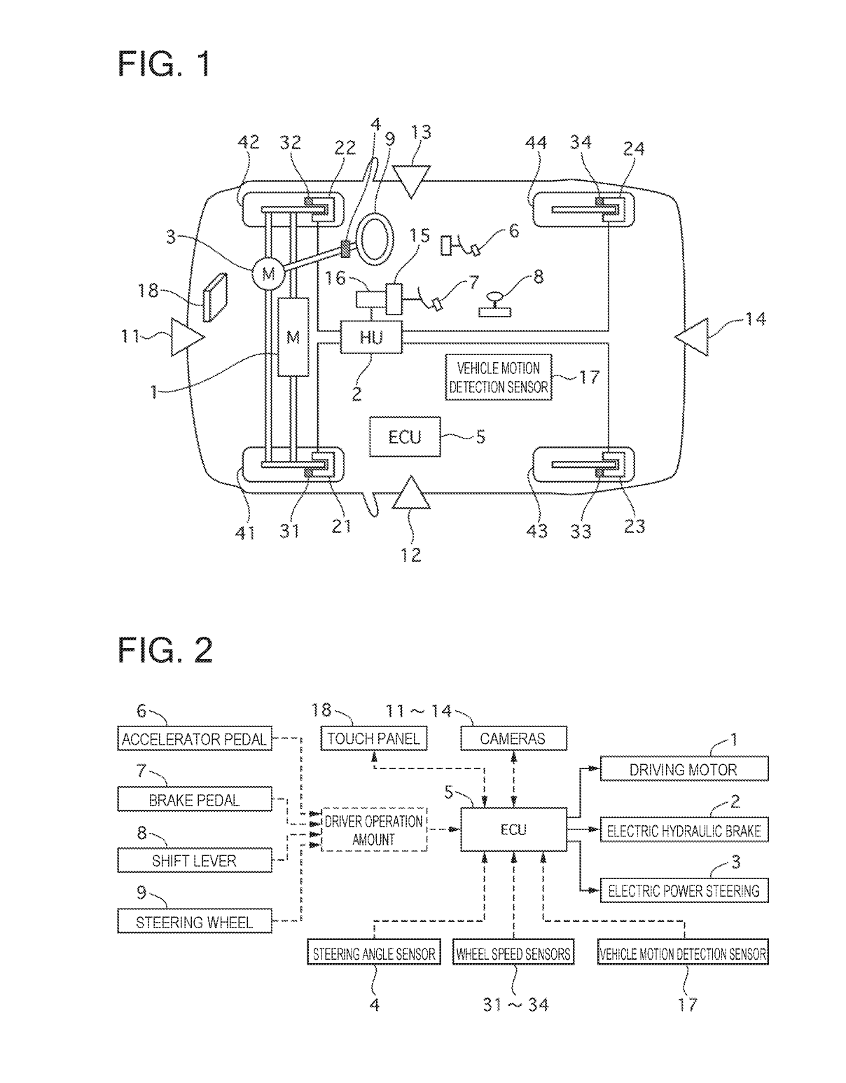

FIG. 1 illustrates a configuration of a vehicle to which a parking assist apparatus according to a first embodiment is applied.

A driver instructs the vehicle to move forward, move backward, or stop with use of a shift lever 8, and instructs the vehicle regarding a driving force of a driving motor 1 with use of an accelerator pedal 6. The driving motor 1 may be an engine. The driving motor 1 can generate the driving force and a braking force independently of the accelerator pedal operation and the shift lever operation performed by the driver.

A pressing force applied to a brake pedal 7 is boosted by an electric booster 15, and a hydraulic pressure according to this force is generated in a master cylinder 16. The generated hydraulic pressure is supplied to wheel cylinders 21 to 24 via an electric hydraulic brake 2. In this manner, the driver controls the braking force with use of the brake pedal 7. The electric booster 15 can control the hydraulic pressure in the master cylinder 16 independently of the brake pedal operation performed by the driver, and the electric hydraulic booster 2 can control braking forces on four wheels (hydraulic pressures in the wheel cylinders 21 to 24) separately from one another with use of a pump driven by a built-in motor, and electromagnetic valves and the like. There is no difference between a left side and a right side in the braking force applied to each of the four wheels according to the brake pedal operation performed by the driver.

An electric power steering 3 generates an assist torque according to a steering torque input from the driver via a steering wheel 9. Then, front left and right wheels 41 and 42 are turned according to the steering torque input from the driver and the assist torque generated by the electric power steering 3, and the vehicle is turned when the vehicle is running. Further, the electric power steering 3 can generate the steering torque to turn the front left and right wheels 41 and 42 independently of the steering operation performed by the driver.

Further, four cameras 11 to 14 are mounted on a front side, a left side, a right side, and a rear side of the vehicle, respectively. The cameras 11 to 14 each capture an image around the vehicle to recognize a target object around the vehicle. The cameras 11 to 14 are each a monocular camera. Images captured by the four cameras 11 to 14 are combined to one another, and are displayed on a touch panel 18 as an overhead view indicating the vehicle and the vicinity of the vehicle overlooked from above. The driver can also park the vehicle while viewing this overhead view without relying on parking assist control.

The paring assist apparatus according to the first embodiment recognizes a parking end position based on a parking frame and a position where another parked vehicle is located on the image captured by any of the cameras 11 to 14, and automatically controls the driving motor 1, the electric hydraulic brake 2, and the electric power steering 3 in such a manner that the vehicle reaches the recognized parking end position. The driver can also instruct the vehicle regarding the parking end position with use of the touch panel 18 where the overhead view is displayed.

Further, a steering angle sensor 4 and wheel speed sensors 31 to 34 are mounted to control a parking trajectory. The electric hydraulic brake 2 performs electronic stability control and anti-block control of the vehicle based on respective sensor signals from a vehicle motion detection sensor 17 that detects a longitudinal acceleration, a lateral acceleration, and a yaw rate, the steering angle sensor 4, and the wheel speed sensors 31 to 34, but the signals from the steering angle sensor 4 and the wheel speed sensors 31 to 34 are also used in common by the parking assist control.

All of the above-described electric apparatuses are controlled by an electronic control unit 5, and all of the respective sensor signals are also input to the electronic control unit 5. The respective sensor signals also include an amount of the accelerator pedal operation, an amount of the brake pedal operation, an amount of the shift lever operation, and the steering torque, each of which is an amount of the operation performed by the driver. Further, the vehicle can also be configured in such a manner that the functions of the electronic control unit 5 are divided and each of the electric apparatuses is provided with an electronic control unit, and required information is communicated among the individual electronic control units.

[Configuration of Parking Assist Apparatus]

FIG. 2 illustrates a configuration of the parking assist apparatus according to the first embodiment.

During a parking operation, the parking assist apparatus automatically controls a motion of the vehicle by the driving motor 1, the electric hydraulic brake 2, and the electric power steering 3 but keeping monitoring the driver operation amount, thereby allowing the driver to override this automatic control. When the driver operates the brake pedal 7, the parking assist apparatus temporarily stops the vehicle, and restarts the parking operation based on the automatic control after the driver releases the brake. Due to this configuration, when an obstacle enters in the parking trajectory, the parking assist apparatus can prioritize the brake operation performed by the driver, and therefore can avoid a contact with the obstacle. After that, when the operation performed on the brake pedal 7 is released, the parking assist apparatus restarts the parking operation based on the automatic control. Due to this configuration, when the obstacle is separated from the parking trajectory, the parking assist apparatus can automatically restart the parking assist. Further, when the driver changes a position of the shift lever or the steering torque input by the driver reaches or exceeds the predetermined torque, the parking assist apparatus cancels the parking operation based on the automatic control. Due to this configuration, the parking assist apparatus can cause the vehicle to run while prioritizing the shift lever operation or the steering operation performed by the driver. The parking assist apparatus can also be configured to display an automatic control cancel button on the touch panel 18 and cancel the automatic control according to pressing of this automatic control cancel button.

[Parking Assist Control]

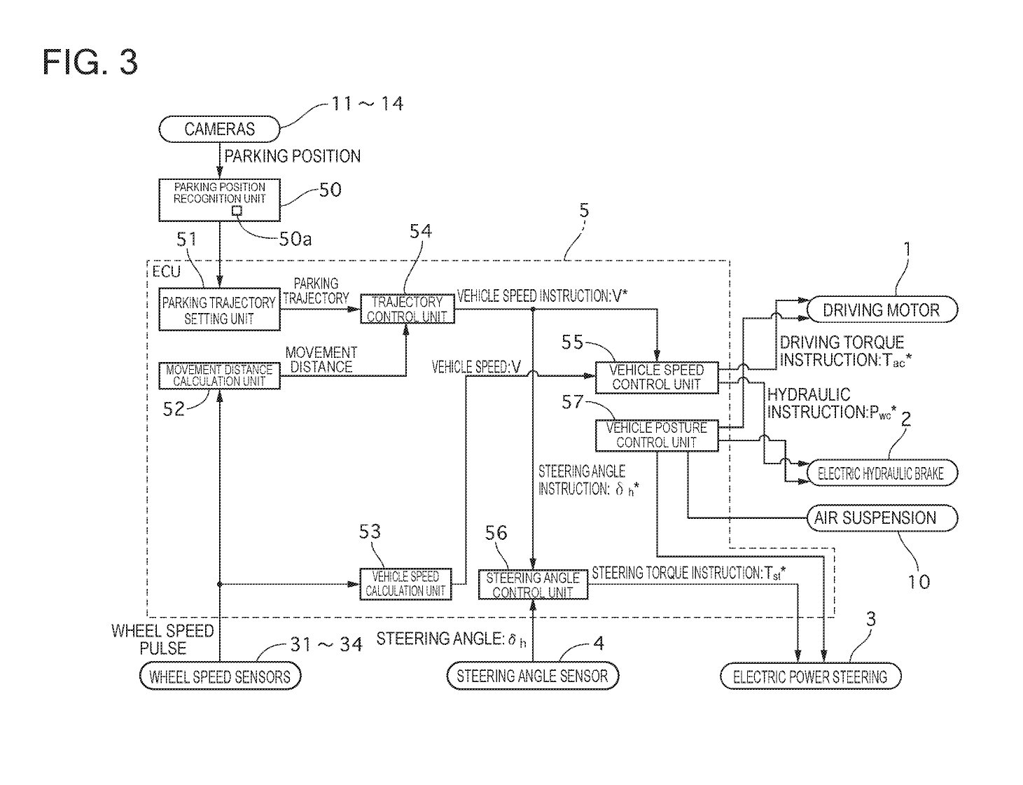

FIG. 3 illustrates a configuration of the parking assist control performed by the electronic control unit 5 according to the first embodiment.

The electronic control unit 5 includes a parking position recognition unit 50, a parking trajectory setting unit 51, a movement distance calculation unit 52, a vehicle speed calculation unit 53, a trajectory control unit 54, a vehicle speed control unit 55, a steering angle control unit 56, and a vehicle posture control unit 57 as a configuration for realizing the parking assist control.

First, the parking position recognition unit 50 recognizes the parking end position from the image captured by any of the cameras 11 to 14 at a parking start position. The parking position recognition unit 50 includes a limited area setting unit 50a, which sets a limited area based on a result of recognizing the obstacle from the image captured by any of the cameras 11 to 14. The parking position recognition unit 50 recognizes a parking space that is equivalent to the parking end position for perpendicularly parking this vehicle itself in the limited area. The parking end position may be specified by the driver with use of the touch panel 18 where the overhead view is displayed as described above.

Next, the parking trajectory setting unit 51 sets the parking trajectory based on the parking end position. The parking trajectory is set only once when the parking operation is started, and is not corrected during the parking operation. The parking trajectory is expressed as a steering angle with respect to a movement distance of the vehicle.

The wheel speed sensors 31 to 34 each generate a wheel speed pulse a plurality of times per rotation of the wheel.

The movement distance calculation unit 52 accumulates how many times the wheel speed pulse is generated to calculate the movement distance of the vehicle. Further, the vehicle speed calculation unit 53 calculates a vehicle speed V with use of a cycle in which the wheel speed pulse is generated. In the first embodiment, a movement distance and a vehicle speed at a center of an axle of the rear wheels are used as the movement distance and the vehicle speed V, so that the vehicle speed calculation unit 53 sets average values of respective movement speeds and wheel speeds at rear left and right wheels 43 and 44 as the movement distance and vehicle speed V required to be calculated.

The trajectory control unit 54 calculates a vehicle speed instruction V* and a steering angle instruction δh* from the parking trajectory and the movement distance of the vehicle. The vehicle speed instruction V* is assumed to be constant during each of a forward movement and a backward movement.

The vehicle speed calculation unit 55 controls the vehicle speed based on the vehicle speed instruction V* and the vehicle speed V, and calculates a driving torque instruction Tac* directed to the driving motor 1 and a hydraulic instruction Pwc* directed to the electric hydraulic brake 2, as the operation amount. The driving motor 1 and the electric hydraulic brake 2 generate a driving force and a braking force according to these instructions. The parking assist apparatus may cause only the driving motor 1 to generate both the driving force and the braking force, or may divide them so as to cause the driving motor 1 to generate the driving force and the electric hydraulic brake 2 to generate the braking force. The first embodiment can be realized by employing the latter method in a case where the driving motor 1 is replaced with the engine. In the first embodiment, the driving motor 1 is used instead of the engine, but the parking assist apparatus causes the driving motor 1 to generate the driving force and the electric hydraulic brake 2 to generate the braking force.

The steering angle control unit 56 controls the steering angle based on a steering angle instruction δh* and a steering angle δh measured by the steering angle sensor 4, and calculates a steering torque instruction Tst* as the operation amount. The electric power steering 3 generates the steering torque according to this instruction.

The vehicle posture control unit 57 controls a posture of the vehicle while the vehicle is stopped. There are three kinds of methods for the control of the posture of the vehicle. The first method is to turn the front left and right wheels 41 and 42 with use of the electric power steering 3 to steer the posture of the vehicle in the left or right direction. The second method is to control the driving motor 1 and the electric hydraulic brake 2 to change the posture of the vehicle in a pitching direction. The third method is to control an air suspension 10 to change the posture of the vehicle in a vertical direction.

[Distance Measurement Control]

The limited area setting unit 50a calculates the distance between the vehicle and the obstacle with use of the image captured by any of the cameras 11 to 14. The cameras 11 to 14 of the parking assist apparatus according to the first embodiment are each the monocular camera. Therefore, the calculation of the distance between the vehicle and the obstacle necessitates at least images acquired by imaging this obstacle from two different locations. In the following description, distance measurement control while the vehicle is running and distance measurement control while the vehicle is stopped will be described.

(Distance Measurement Control while Vehicle is Running)

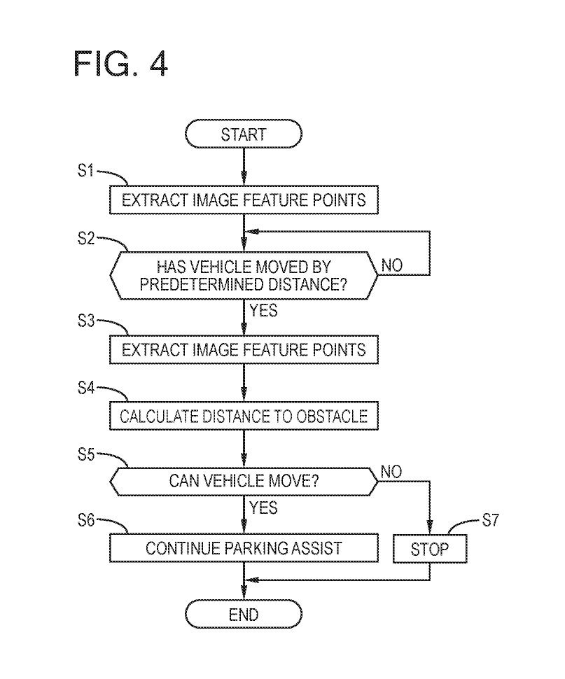

FIG. 4 is a flowchart illustrating a flow of the distance measurement control while the vehicle is running.

In step S1, the parking assist apparatus extracts a contour of the obstacle from the image captured by any of the cameras 11 to 14 as a plurality of image feature points. Then, the processing proceeds to step S2.

In step S2, the parking assist apparatus determines whether the vehicle has moved by a predetermined distance. If the vehicle has moved by the predetermined distance, the processing proceeds to step S3. If the vehicle has not moved by the predetermined distance, the parking assist apparatus repeats the procedure in step S2.

In step S3, the parking assist apparatus extracts, as a plurality of image feature points, the contour of the obstacle from the image captured by the any of the cameras 11 to 14 after the vehicle has moved. Then, the processing proceeds to step S4.

In step S4, the parking assist apparatus calculates the distance between the vehicle and the obstacle. Then, the processing proceeds to step S5. The distance between the vehicle and the obstacle can be acquired with use of the image captured by any of the cameras 11 to 14 in step S1 and the image captured by any of the cameras 11 to 14 in step S3 as a parallax.

In step S5, the parking assist apparatus determines whether the vehicle can move. If the vehicle can move, the processing proceeds to step S6. If the vehicle cannot move, the processing proceeds to step S7. The parking assist apparatus determines that the vehicle can move if the distance between the vehicle and the obstacle is a predetermined distance or longer.

In step S6, the parking assist apparatus continues the parking assist, and ends the processing.

In step S7, the parking assist apparatus stops the vehicle, and ends the processing.

(Distance Measurement Control while Vehicle is Stopped)

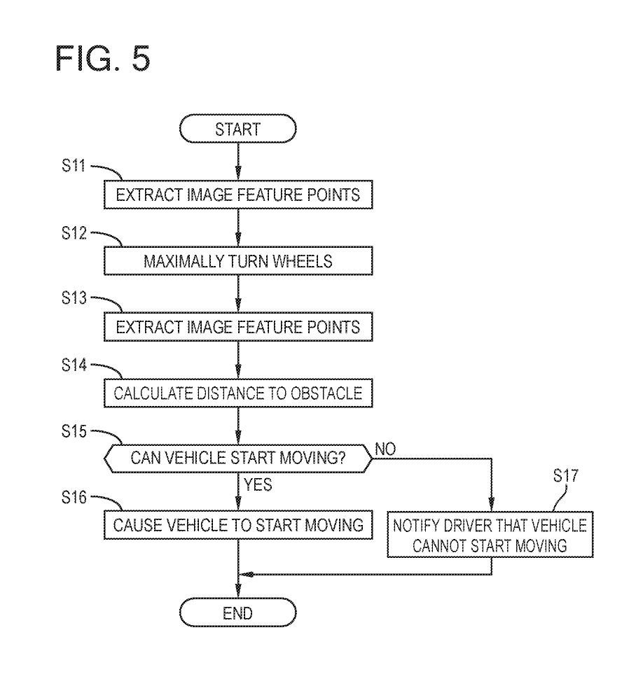

FIG. 5 is a flowchart illustrating a flow of the distance measurement control while the vehicle is stopped.

In step S11, the parking assist apparatus extracts the contour of the obstacle from the image captured by any of the cameras 11 to 14 as a plurality of image feature points. Then, the processing proceeds to step S12.

In step S12, the parking assist apparatus causes the electric power steering 3 to turn the front left and right wheels 41 and 42 in one of the left and right directions so as to reach a maximum turning amount. Then, the processing proceeds to step S13.

In step S13, the parking assist apparatus extracts, as a plurality of image feature points, the contour of the obstacle from the image captured by any of the cameras 11 to 14 after the wheels have been turned. Then, the processing proceeds to step S14.

In step S14, the parking assist apparatus calculates the distance between the vehicle and the obstacle. Then, the processing proceeds to step S15. The distance between the vehicle and the obstacle can be acquired with use of the image captured by any of the cameras 11 to 14 in step S11 and the image captured by any of the cameras 11 to 14 in step S13 as a parallax.

In step S15, the parking assist apparatus determines whether the vehicle can start moving. If the vehicle can start moving, the processing proceeds to step S16. If the vehicle cannot start moving, the processing proceeds to step S17. The parking assist apparatus determines that the vehicle can start moving if the distance between the vehicle and the obstacle is the predetermined distance or longer.

In step S16, the parking assist apparatus causes the vehicle to start moving and carries out the parking assist, and ends the processing.

In step S17, the parking assist apparatus notifies the driver that the vehicle cannot start moving, and ends the processing.

(Distance Measurement Method)

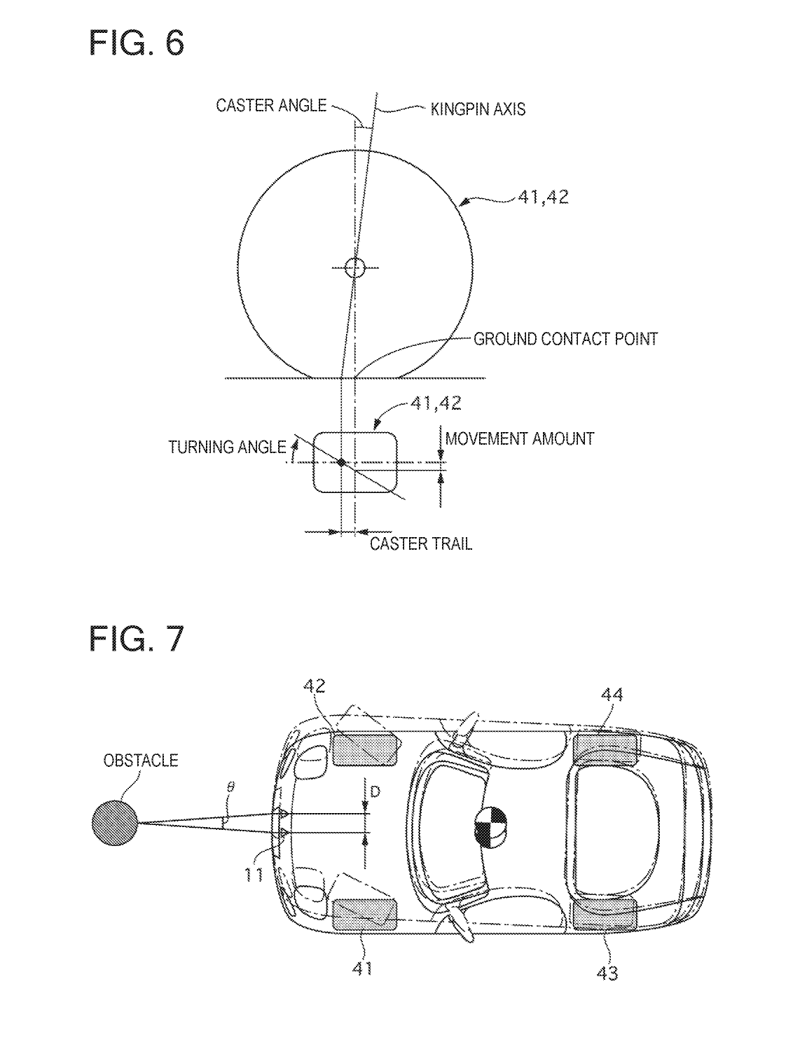

FIG. 6 schematically illustrates the front left or right wheel 41 or 42. The wheel is attached with a kingpin axis thereof inclined at a caster angle, so that a point on a road surface which an extension line of the kingpin axis passes through is spaced apart from a point at which a tire contacts the ground (a caster trail). Since a line along a turning axis of the front left or right wheel 41 or 42 does not coincide with the point at which the tire contacts the ground, turning the front left or right wheel 41 or 42 causes a displacement of the point at which the tire contacts the ground. Therefore, this leads to a movement of the vehicle in a vehicle width direction.

Now, supposing that the caster trail is 25 [mm] and a steering angle (the turning angle) of the front left or right wheel 41 or 42 is 40 [° ], an amount of the displacement of the point at which the tire contacts the ground is determined to be 16 [mm] by the following equation.

25 [mm]×sin 40[°]=16 [mm]

This means that, supposing that a distance in the longitudinal direction of the vehicle between a front axle and a position of the camera is 1 m and a wheelbase is 2.5 m, the position of the camera 11 mounted on the front side of the vehicle is changed by a positional change D of 22.4 mm between when the front left and right wheels 41 and 42 are located at positions that cause the vehicle to move straight and when the front left and right wheels 41 and 42 are turned at the turning angle 40 [°], according to the following equation.

16 [mm]×(1 [m]+2.5 [m])/2.5 [m]=22.4 [mm]

FIG. 7 illustrates a method for calculating the distance between the vehicle and the obstacle. Now, suppose that an angular difference θ is 1[°] between a direction of the obstacle with respect to the camera 11 when the front left and right wheels 41 and 42 are located at the positions that cause the vehicle to move straight, and a direction of the obstacle with respect to the camera 11 when the front left and right wheels 41 are 42 are turned at the turning angle 40 [°]. The distance L from the vehicle to the obstacle can be calculated and determined to be 1283 [mm] by the following equation.

22.4 [mm]/tan 1[°]=1283 [mm]

[Functions]

The measurement of the distance between the vehicle and the obstacle from the image captured by using the monocular camera alone necessitates at least images captured from different two locations. While the vehicle is running, the vehicle is moving and therefore the obstacle can be imaged from two locations. However, while the vehicle is stopped, the obstacle cannot be imaged from two locations and therefore the distance cannot be measured. Causing the vehicle to start moving allows the distance to be measured, but causing the vehicle to start moving without knowing the distance between the vehicle and the obstacle raises a risk of a contact with the obstacle.

Therefore, in the first embodiment, the parking assist apparatus is configured to change the posture of the vehicle while the vehicle is stopped, and calculate the distance to the object based on the image of the obstacle that is captured by any of the cameras 11 to 14 and the change in the posture of the vehicle. Due to this configuration, the parking assist apparatus can measure the distance between the vehicle and the obstacle even while the vehicle is stopped, because the positions of the cameras 11 to 14 relative to the obstacle are changed.

Further, in the first embodiment, the parking assist apparatus is configured in such a manner that the cameras 11 to 14 are mounted one by one at each of the front side, the left side, the right side, and the rear side. Since being configured to change the posture of the vehicle, the parking assist apparatus can measure the distance between the vehicle and the obstacle even with use of the monocular camera alone.

Further, in the first embodiment, the parking assist apparatus is configured to calculate the distance based on the change between the image captured by any of the cameras 11 to 14 before the posture of the vehicle is controlled by the vehicle posture control unit 57 and the image captured after the control is started. Due to this configuration, the parking assist apparatus can easily measure the distance between the vehicle and the obstacle based on the images before and after the vehicle posture control.

Further, in the first embodiment, the parking assist apparatus is configured to calculate the distance between the vehicle and the obstacle with use of the change in the image captured by any of the cameras 11 to 14 due to the change in the posture of the vehicle as the parallax. Due to this configuration, the parking assist apparatus can easily measure the distance between the vehicle and the obstacle by using the change in the image captured by any of the cameras 11 to 14 as the parallax.

Further, in the first embodiment, the parking assist apparatus is configured to automatically cause the electric power steering 3 to turn the wheels to change the posture of the vehicle. Due to this configuration, the parking assist apparatus can change the posture of the vehicle with use of the existing apparatus without use of a new apparatus only for the vehicle posture control. Therefore, the parking assist apparatus can measure the distance between the vehicle and the obstacle while the vehicle is stopped, at low cost.

[Advantageous Effects]

(1) The vehicle control apparatus includes the cameras 11 to 14 mounted on the vehicle and each configured to image the object in the predetermined direction, the vehicle posture control unit 57 mounted on the vehicle and configured to change the posture of the vehicle while the vehicle is stopped, and the limited area setting unit 50 (a distance calculation unit) configured to calculate the distance to the object based on the information imaged by any of the cameras 11 to 14 and the change in the posture by the vehicle posture control unit 57.

Therefore, the first embodiment allows the position of any of the cameras 11 to 14 to be changed and therefore allows the distance between the vehicle and the object to be measured even while the vehicle is stopped.

(2) As the cameras 11 to 14, one camera is mounted with respect to the predetermined direction.

Therefore, the first embodiment allows the distance between the vehicle and the object to be measured even from the image captured by one camera.

(3) The limited area setting unit 50a calculates the distance based on the change between the information imaged by any of the cameras 11 to 14 before the posture of the vehicle is controlled by the vehicle posture control unit 57 and the information imaged after the control is started.

Therefore, the first embodiment allows the distance between the vehicle and the object to be easily measured based on the information before and after the vehicle posture control.

(4) The limited area setting unit 50a calculates the distance by using the change in the information imaged by any of the cameras 11 to 14 as the parallax.

Therefore, the first embodiment allows the distance between the vehicle and the obstacle to be easily measured.

(5) The vehicle includes the electric power steering 3 (an electric power steering apparatus). The vehicle posture control unit 57 changes the posture of the vehicle by automatically causing the electric power steering 3 to turn the vehicle.

Therefore, the first embodiment allows the distance between the vehicle and the obstacle to be measured while the vehicle is stopped, at low cost.

(6) The vehicle includes the electric power steering 3 (a vehicle posture change apparatus). The vehicle posture control unit 57 changes the posture of the vehicle by activating the electric power steering 3.

Therefore, the first embodiment allows the distance between the vehicle and the object to be easily measured by changing the posture of the vehicle.

(7) The electric power steering 3 is the apparatus for changing the vehicle in the left/right direction. The limited area setting unit 50a calculates the distance based on the change in the vehicle in the left/right direction.

Therefore, the first embodiment allows the distance between the vehicle and the object to be easily measured by changing the posture of the vehicle.

(8) The vehicle control apparatus includes the cameras 11 to 14 (a monocular camera) mounted on the vehicle and each configured to image the object in the predetermined direction, the vehicle posture control unit 57 (a camera position change unit) configured to change the position of any of the cameras 11 to 14, and the limited area setting unit 50a (a distance calculation unit) configured to calculate the distance to the object based on the information imaged by any of the cameras 11 to 14 before and after the position of the camera is changed by the vehicle posture control unit 57 while the vehicle is stopped.

Therefore, the first embodiment allows the position of any of the cameras 11 to 14 to be changed and therefore allows the distance between the vehicle and the object to be measured even while the vehicle is stopped.

### Second Embodiment

In the first embodiment, the parking assist apparatus causes the electric power steering 3 to turn the front left and right wheels 41 and 42 to change the posture of the vehicle in the left or right direction. In the second embodiment, the parking assist apparatus is configured to control the driving motor 1 and the electric hydraulic brake 2 to change the posture of the vehicle in a pitching direction. The second embodiment will be described, identifying a similar configuration to the first embodiment by the same reference numeral and omitting a description thereof.

[Distance Measurement Control]

(Distance Measurement Control while Vehicle is Stopped)

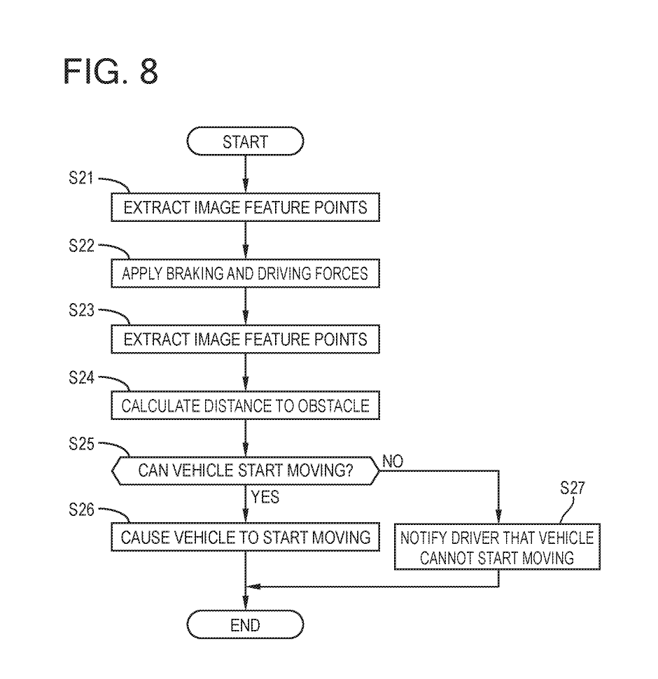

FIG. 8 is a flowchart illustrating a flow of the distance measurement control while the vehicle is stopped.

In step S21, the parking assist apparatus extracts the contour of the obstacle from the image captured by any of the cameras 11 to 14 as a plurality of image feature points. Then, the processing proceeds to step S22.

In step S22, the parking assist apparatus causes the driving motor 1 to generate the driving force and also causes the electric hydraulic brake 2 to generate the braking force. Then, the processing proceeds to step S23.

In step S23, the parking assist apparatus extracts the contour of the obstacle from the image captured by any of the cameras 11 to 14 with the braking force and the driving force generated as a plurality of image feature points. Then, the processing proceeds to step S24.

In step S24, the parking assist apparatus calculates the distance between the vehicle and the obstacle. Then, the processing proceeds to step S25. The distance between the vehicle and the obstacle can be acquired with use of the image captured by any of the cameras 11 to 14 in step S21 and the image captured by any of the cameras 11 to 14 in step S23 as a parallax.

In step S25, the parking assist apparatus determines whether the vehicle can start moving. If the vehicle can start moving, the processing proceeds to step S26. If the vehicle cannot start moving, the processing proceeds to step S27. The parking assist apparatus determines that the vehicle can start moving if the distance between the vehicle and the obstacle is the predetermined distance or longer.

In step S26, the parking assist apparatus causes the vehicle to start moving and carries out the parking assist, and ends the processing.

In step S27, the parking assist apparatus notifies the driver that the vehicle cannot start moving, and ends the processing.

(Distance Measurement Method)

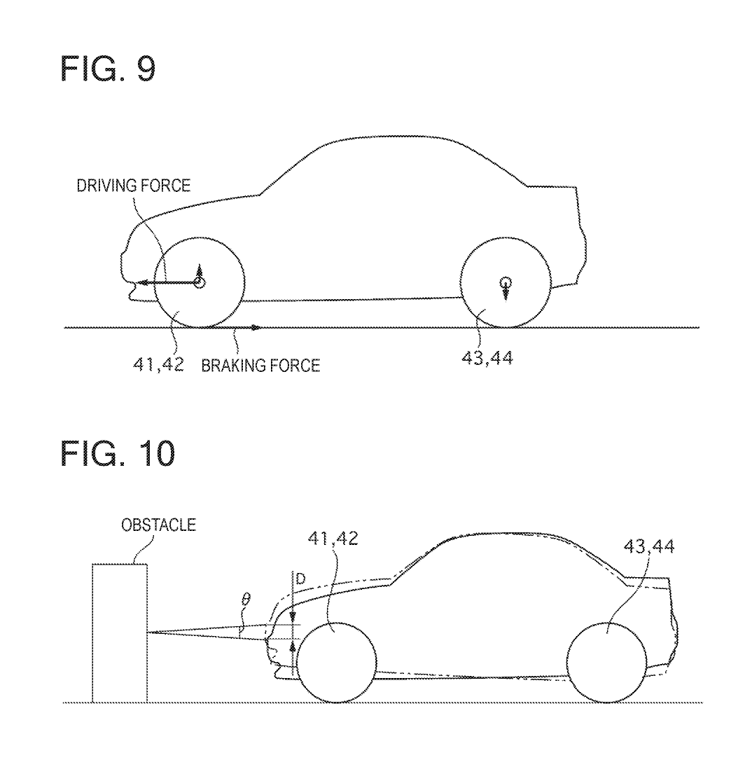

FIG. 9 schematically illustrates the vehicle. The parking assist apparatus can generate a moment in the pitching direction on the vehicle by causing the driving motor 1 to generate the driving force and the electric hydraulic brake 2 to generate the braking force at the same time. The driving force is applied to a wheel center, and the braking force is applied to the point at which the tire contacts the ground.

Supposing that a radius of the tire is 0.3 [m] and the driving force is 300 [kgf], the moment applied to the axle is determined to be 90 [kgfm] by the following equation.

0.3 [m]×300 [kgf]=90 [kgfm]

Supposing that the wheelbase is 2.5 [m], a force applied to suspensions on the wheels on each of the front side and the rear side is determined to be 36 [kgf] by the following equation.

90 [kgfm]/2.5 [m]=36 [kgf]

Supposing that a spring constant of the suspension is 2 [kgf/mm] (4 [kgf/mm] for both the left and right wheels), the application of the force leads to an increase in a height of the vehicle on the front side by 9 [mm] and a reduction in the height of the vehicle on the rear side by 9 [mm], according to the following equation.

36 [kgf]/4 [kgf/mm]=9 [mm]

Supposing that the distance from the position of the tire on the front wheel to the camera 11 mounted on the front side is 1 [m], because the distance from a center between the front and rear wheels to the front wheel is half of the wheelbase (1.25 [m]), a change in the position of the camera 11 is determined to be 16.2 [mm] by the following equation.

9 [mm]×(1.25 [m]+1 [m])/1.25 [m]=16.2 [mm]

FIG. 10 illustrates a method for calculating the distance between the vehicle and the obstacle. Now, suppose that the angular difference θ is 1 [°] between a direction of the obstacle with respect to the camera 11 before the braking force and the driving force are generated, and a direction of the obstacle with respect to the camera 11 after the braking force and the driving force are generated. The distance L from the vehicle to the obstacle can be calculated and determined to be 928 [mm] from the following equation.

16.2 [mm]/tan 1[° ]=928 [mm]

[Functions]

In the second embodiment, the parking assist apparatus is configured to automatically activate the driving motor 1 and the electric hydraulic brake 2 to cause them to change the posture of the vehicle. Due to this configuration, the parking assist apparatus can change the posture of the vehicle with use of the existing apparatuses without use of a new apparatus only for the vehicle posture control. Therefore, the parking assist apparatus can measure the distance between the vehicle and the obstacle while the vehicle is stopped, at low cost.

### [Advantageous Effects]

(9) The vehicle includes the driving motor 1 (a driving apparatus) and the electric hydraulic brake 2 (a braking apparatus). The vehicle posture control unit 57 changes the posture of the vehicle by automatically activating the driving motor 1 and the electric hydraulic brake 2.

Therefore, the second embodiment allows the distance between the vehicle and the obstacle to be measured while the vehicle is stopped, at low cost.

(10) The driving motor 1 and the electric hydraulic brake (a vehicle posture change apparatus) are the apparatuses for changing the vehicle in the pitching direction. The limited area setting unit 50a calculates the distance based on the change in the vehicle in the pitching direction.

Therefore, the second embodiment allows the distance between the vehicle and the object to be easily measured by changing the posture of the vehicle.

### Third Embodiment

In the first embodiment, the parking assist apparatus causes the electric power steering 3 to turn the front left and right wheels 41 and 42 to change the posture of the vehicle in the left or right direction. In the third embodiment, the parking assist apparatus is configured to change the posture of the vehicle in a vertical direction by controlling the air suspension 10. The third embodiment will be described, identifying a similar configuration to the first embodiment by the same reference numeral and omitting a description thereof.

[Distance Measurement Control]

(Distance Measurement Control while Vehicle is Stopped)

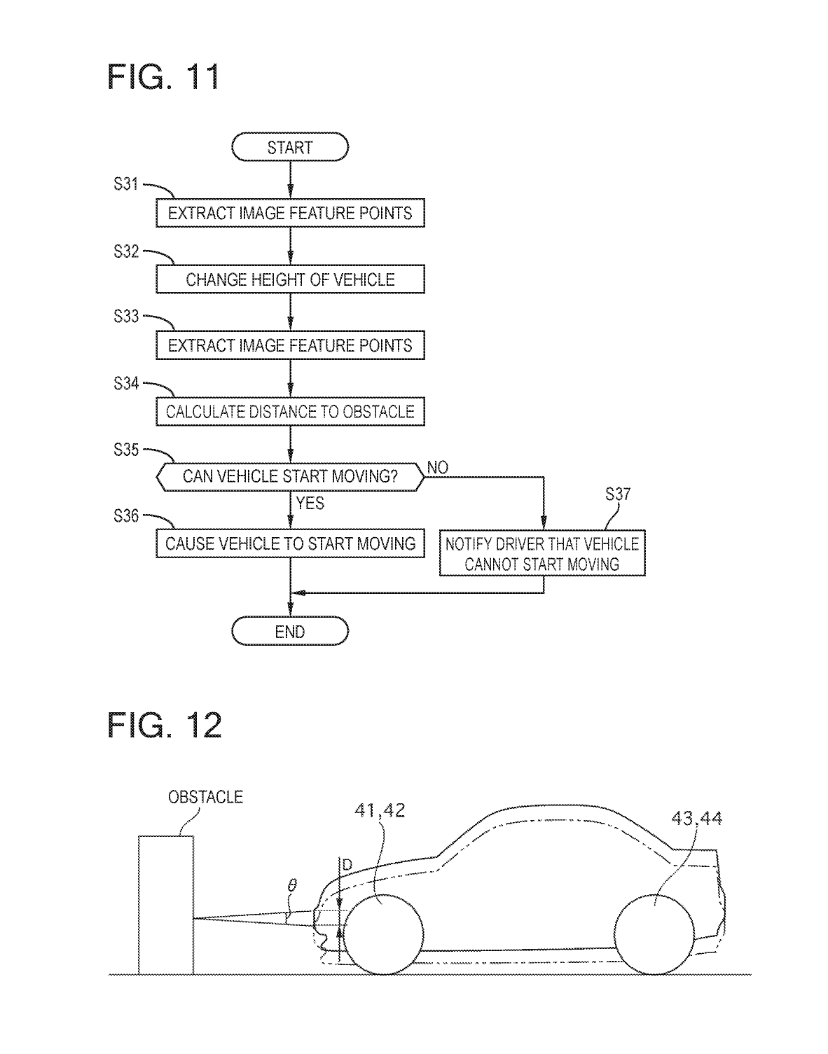

FIG. 11 is a flowchart illustrating a flow of the distance measurement control while the vehicle is stopped.

In step S31, the parking assist apparatus extracts the contour of the obstacle from the image captured by any of the cameras 11 to 14 as a plurality of image feature points. Then, the processing proceeds to step S32.

In step S32, the parking assist apparatus causes the air suspension to change the height of the vehicle. Then, the processing proceeds to step S33.

In step S33, the parking assist apparatus extracts, as a plurality of image feature points, the contour of the obstacle from the image captured by any of the cameras 11 to 14 with the height of the vehicle changed. Then, the processing proceeds to step S34.

In step S34, the parking assist apparatus calculates the distance between the vehicle and the obstacle. Then, the processing proceeds to step S35. The distance between the vehicle and the obstacle can be acquired with use of the image captured by any of the cameras 11 to 14 in step S31 and the image captured by any of the cameras 11 to 14 in step S33 as a parallax.

In step S35, the parking assist apparatus determines whether the vehicle can start moving. If the vehicle can start moving, the processing proceeds to step S36. If the vehicle cannot start moving, the processing proceeds to step S37. The parking assist apparatus determines that the vehicle can start moving if the distance between the vehicle and the obstacle is the predetermined distance or longer.

In step S36, the parking assist apparatus causes the vehicle to start moving and carries out the parking assist, and ends the processing.

In step S37, the parking assist apparatus notifies the driver that the vehicle cannot start moving, and ends the processing.

(Distance Measurement Method)

FIG. 12 illustrates a method for calculating the distance between the vehicle and the obstacle. Now, suppose that the angular difference θ is 1[°] between a direction of the obstacle with respect to the camera 11 before the height of the vehicle is changed, and a direction of the obstacle with respect to the camera 11 after the height of the vehicle is changed. Supposing that the height of the vehicle is changed by 20 [mm], the distance L from the vehicle to the obstacle can be calculated and determined to be 1146 [mm] by the following equation.

20 [mm]/tan 1[°]=1146 [mm]

[Functions]

In the third embodiment, the parking assist apparatus is configured to automatically activate the air suspension 10 to cause it to change the posture of the vehicle. Due to this configuration, the parking assist apparatus can change the posture of the vehicle with use of the existing apparatus without use of a new apparatus only for the vehicle posture control. Therefore, the parking assist apparatus can measure the distance between the vehicle and the obstacle while the vehicle is stopped, at low cost.

### [Advantageous Effects]

(11) The vehicle includes the air suspension 10 (a vehicle height adjustment apparatus). The vehicle posture control unit 57 changes the posture of the vehicle by automatically activating the air suspension 10.

Therefore, the third embodiment allows the distance between the vehicle and the obstacle to be measured while the vehicle is stopped, at low cost.

(12) The air suspension 10 (a vehicle posture change apparatus) is the apparatus for changing the vehicle in the vertical direction. The limited area setting unit 50a calculates the distance based on the change in the vehicle in the vertical direction.

Therefore, the third embodiment allows the distance between the vehicle and the object to be easily measured by changing the posture of the vehicle.

### OTHER EMBODIMENTS

Having described the present invention based on the first to third embodiments, the specific configuration of each invention is not limited to the first to third embodiments, and the present invention also includes a design modification and the like thereof made within a range that does not depart from the spirit of the present invention.

In the first to third embodiments, the parking assist apparatus is configured to control the posture of the vehicle with use of the existing apparatus mounted on the vehicle (the electric power steering 3, the driving motor 1 and the electric hydraulic brake 2, or the air suspension 10). However, the parking assist apparatus may be configured not to use these apparatuses and instead utilize a change in the height of the vehicle when, for example, a passenger gets in or out of the vehicle. In this case, for example, the parking assist apparatus activates the cameras 11 to 14 in advance before the passenger gets in the vehicle (for example, when a door lock is released), and measures the distance between the vehicle and the obstacle with use of a change in the height of the vehicle after the passenger gets in the vehicle. Further, similar effects can also be acquired by configuring the parking assist apparatus to change the position of the camera itself by driving the camera with use of an actuator, instead of changing the posture of the vehicle.

Having described several embodiments of the present invention, the above-described embodiments of the present invention are intended to only facilitate the understanding of the present invention, and are not intended to limit the present invention thereto. Needless to say, the present invention can be modified or improved without departing from the spirit of the present invention, and includes equivalents thereof. Further, the individual components described in the claims and the specification can be arbitrarily combined or omitted within a range that allows them to remain capable of achieving at least a part of the above-described objects or producing at least a part of the above-described advantageous effects.

The present application claims priority to Japanese Patent Application No. 2015-018284 filed on Feb. 2, 2015. The entire disclosure of Japanese Patent Application No. 2015-018284 filed on Feb. 2, 2015 including the specification, the claims, the drawings, and the abstract is incorporated herein by reference in its entirety.

### REFERENCE SIGN LIST

1 driving motor (braking apparatus, vehicle posture change apparatus)
2 electric hydraulic brake (driving apparatus, vehicle posture change apparatus)
3 electric power steering (electric steering apparatus)
10 air suspension (vehicle height adjustment apparatus, vehicle posture change apparatus)
11 to 14 camera (monocular camera)
50a limited area setting unit (distance calculation unit)
57 vehicle posture control unit (camera position change unit)

1. A vehicle control apparatus comprising:
a camera mounted on a vehicle and configured to image an object in a predetermined direction;
a vehicle posture control unit mounted on the vehicle and configured to change a posture of the vehicle while the vehicle is stopped; and
a distance calculation unit configured to calculate a distance to the object based on information imaged by the camera and the change in the posture by the vehicle posture control unit.

2. The vehicle control apparatus according to claim 1, wherein as the camera, one camera is mounted with respect to the predetermined direction.

3. The vehicle control apparatus according to claim 2, wherein the distance calculation unit calculates the distance based on information imaged by the camera before the posture of the vehicle is controlled by the vehicle posture control unit and a change in the information imaged after the control is started.

4. The vehicle control apparatus according to claim 3, wherein the distance calculation unit calculates the distance by using the change in the information as a parallax.

5. The vehicle control apparatus according to claim 4, wherein the vehicle includes an electric power steering apparatus, and
wherein the vehicle posture control unit changes the posture of the vehicle by automatically causing the electric power steering apparatus to turn the vehicle.

6. The vehicle control apparatus according to claim 4, wherein the vehicle includes a braking apparatus and a driving apparatus, and
wherein the vehicle posture control unit changes the posture of the vehicle by automatically activating the braking apparatus and the driving apparatus.

7. The vehicle control apparatus according to claim 4, wherein the vehicle includes a vehicle height adjustment apparatus, and
wherein the vehicle posture control unit changes the posture of the vehicle by automatically activating the vehicle height adjustment apparatus.

8. The vehicle control apparatus according to claim 1, wherein the vehicle includes a vehicle posture change apparatus, and
wherein the vehicle posture control unit changes the posture of the vehicle by activating the vehicle posture change apparatus.

9. The vehicle control apparatus according to claim 8, wherein the vehicle posture change apparatus is an apparatus for changing the vehicle in a left/right direction, and
wherein the distance calculation unit calculates the distance based on the change in the vehicle in the left/right direction.

10. The vehicle control apparatus according to claim 8, wherein the vehicle posture change apparatus is an apparatus for changing the vehicle in a pitching direction, and
wherein the distance calculation unit calculates the distance based on the change in the vehicle in the pitching direction.

11. The vehicle control apparatus according to claim 8, wherein the vehicle posture change apparatus is an apparatus for changing the vehicle in a vertical direction, and
wherein the distance calculation unit calculates the distance based on the change in the vehicle in the vertical direction.

12. A distance calculation apparatus for a vehicle, the distance calculation apparatus comprising:
a monocular camera mounted on the vehicle and configured to image an object in a predetermined direction;
a camera position change unit configured to change a position of the monocular camera; and
a distance calculation unit configured to calculate a distance to the object based on information imaged by the monocular camera before and after a position of the camera is changed by the camera position change unit while the vehicle is stopped.

13. The distance calculation apparatus according to claim 12, wherein the vehicle includes an electric power steering apparatus, and
wherein the camera position change unit changes the position of the monocular camera by automatically causing the electric power steering apparatus to turn the vehicle.

14. The distance calculation apparatus according to claim 12, wherein the vehicle includes a braking apparatus and a driving apparatus, and
wherein the camera position change unit changes the position of the monocular camera by automatically activating the braking apparatus and the driving apparatus.

15. The distance calculation apparatus according to claim 12, wherein the vehicle includes a vehicle height adjustment apparatus, and
wherein the camera position change unit changes the position of the monocular camera by automatically activating the vehicle height adjustment apparatus.

16. A distance calculation method comprising:
imaging an object in a predetermined direction of a vehicle with use of a camera; and
calculating a distance to the object based on information of the imaging before an actuator mounted on the vehicle and configured to control a posture of the vehicle is driven and information of the imaging after the actuator is driven.

17. The distance calculation method according to claim 16, wherein the actuator is an electric power steering apparatus, and
wherein the distance calculation method further includes changing the posture of the vehicle by automatically causing the electric power steering apparatus to turn the vehicle.

18. The distance calculation method according to claim 16, wherein the actuator is a braking apparatus and a driving apparatus, and
wherein the distance calculation method further includes changing the posture of the vehicle by automatically activating the braking apparatus and the driving apparatus

19. The distance calculation method according to claim 16, wherein the actuator is a vehicle height adjustment apparatus, and
wherein the distance calculation method further includes changing the posture of the vehicle by automatically activating the vehicle height adjustment apparatus.
